(19) United States
(12) Patent Application Publication
(10) Pub. No.: US 2020/0206050 A1
(43) Pub. Date: Jul. 2, 2020

(54) NURSING BED FOR SITTING EXCRETION

(71) Applicants: CHENG-PIAO LAI, TAOYUAN CITY (TW); TING-YU LAI, TAOYUAN CITY (TW)

(72) Inventors: CHENG-PIAO LAI, TAOYUAN CITY (TW); TING-YU LAI, TAOYUAN CITY (TW)

(21) Appl. No.: 16/621,357

(22) PCT Filed: Apr. 8, 2018
(86) PCT No.: PCT/CN2018/000130

§ 371 Date: Dec. 11, 2019

(30) Foreign Application Priority Data
Feb. 13, 2018 (CN) 201810149268.X

(51) Int. Cl. A61G 7/02; A61G 7/015; A61G 7/018; F16C 1/10; F16H 21/52; A47K 7/08

(52) U.S. Cl. CPC A61G 7/02; A61G 7/015; A61G 7/018; A61G 2203/10; F16H 21/52; A47K 7/08; F16C 1/10

(57) ABSTRACT

A nursing bed for sitting excretion comprises a strength saving transmission device arranged inside the bed frame; a bed board device arranged above the strength saving transmission device; an excretion device arranged between the bed board device and the strength saving transmission device; the strength saving transmission device drives a driving mechanism by a power output shaft, and the driving mechanism drives a first elevation rod and a second elevation rod, the first elevation rod drives the back moveable frame to be leaned, the second elevation drives the leg moveable frame to be lowering; The present invention uses the law of the lever to achieve providing a device with strength saving feature, and further achieve the effects of allowing the patient excreting with sitting posture to reduce the discomfort and increase the convenience, and achieve self-caring.

### BACKGROUND OF THE INVENTION

### 1. Field of the Invention

The invention relates to a nursing bed for sitting excretion, especially to one that uses the law of the lever to achieve providing a device with strength saving feature.

### 2. Description of the Related Art

As population aging becomes more serious, many illnesses that tend to happen to elders are more common such as strokes, brain diseases, paralysis, central nervous system damages, and other illnesses. These illnesses cause a person to lie on a bed for most of the time, and require the families and nursing personnel's full attention and strength for caring. And when it comes to daily routine like excretion and bathing, it is inconvenient and even self-esteem hurting. The patients have to rely on others' help to go to the bath room; many of them also have a simple tool for urinate at bedsides. Such situations are tiring for the caregivers and even more embarrassing and mentally burdening for the patients.

FIG. 1A and FIG. 1B illustrated an automatic nursing bed, China patent No CN101912332A, it comprising: a bed body 1, a moveable bed plate 131 arranged on the bed body, an intermediate bed plate 132, a leg moveable bed plate 133, and a care hole 132a; in order to let the patient able to finish excretion in the bed, the moveable bed plate 131 and the leg moveable bed plate 133 must having a driving unit 131a and 133a arranged under their bottom, and make it to be rise up status as FIG. 1 B showing. The driving unit 131a and 133a using in prior art is drove by pneumatic cylinder, however the driving unit 131a and 133a is arranged under the bed body 1, driving directly to rise the moveable bed plate 131 and the intermediate bed plate 132 up, it required a lot of energy, so the it wastes a lot of power, what's more, the driving unit 133a is arranged at the bottom of the leg moveable bed plate 133, so the leg moveable bed plate 133 can only rise up but not fall down, thus, as FIG. 1B showing, when the patient excretes by the care hole 132a, their leg must lift up, it is not a comfortable posture and needed to be improved.

### SUMMARY OF THE INVENTION

It is a primary objective of the present invention to provide a nursing bed for sitting excretion that allow the patient to excrete on the bed with sitting posture, so as to increase convenience and achieve the effect of self-care.

It is another objective of the present invention to provide a nursing bed for sitting excretion, the driving units of the back moveable frame and the leg moveable frame are using the law of lever to achieve the effect of strength saving and improve convenience and comfort.

It is another objective of the present invention to provide a nursing bed for sitting excretion that has both manual and electric operating mode.

In order to achieve the above objectives, the present invention comprising, a bed frame formed by an outer frame and multiple frame supports connected to the outer frame, and the longer side is defined as horizontal direction, the shorter side is defined as vertical direction; a strength saving transmission device arranged inside the bed frame; a bed board device arranged above the strength saving transmission device; an excretion device arranged between the bed board device and the strength saving transmission device; wherein the strength saving transmission device, including: a back moveable frame having a back frame, the bottom of the back frame is connected to a first vertical shaft rod, the first vertical shaft rod having a first crank, a first shaft seat is arranged at the both side of the bed frame; a leg moveable frame including two horizontal connecting rods arranged parallelly, the bottom of the horizontal connecting rods are connected to a second vertical shaft rod, a second crank arranged on the second vertical shaft rod, a second shaft seat arranged on the frame supports on the both side, at the center of the horizontal connecting rods set a hinge, and at the outer side of the hinge arranged multiple support bars; a control device arranged on the outer frame of the bed frame, comprising: a). a first power output shaft, at the end of the first power output shaft arranged a third shaft seat, and having a first driven gear; b). a first hand crank capable of turning 360° arranged on the tube body, and drives a fourth shaft seat arranged on the first driving gear, the first driving gear is screwed with the first driven gear, by the rotating of the hand crank drives the power output shaft to rotate; c). a motor is fixed on the outer frame by a board unit, and on spindle of the motor arranged a second driving gear; d). a second power output shaft arranged on the outer frame, having a second driven gear screwed with the second driving gear, and the second power output shaft is at the same axle corresponding to the first power output shaft; e). a first clutch is arranged axially among the first power output shaft and the second power output shaft, the first clutch includes a first tube sleeve and a first spring arranged on the end of the first power output shaft, and the first tube sleeve is able to slide on the first power output shaft, and at the end of the first tube sleeve which far form the first spring arranged a first bonding part with concave-convex surface, a second bonding part is connected to the second power output shaft and it can be engaged to the first bonding part or disengaged from the first bonding part; f). a panel having a turn knob arranged above the first clutch, by turning the turn knob drive the first tube sleeve to move linearly, and further control the combination status of the first bonding part and the second bonding part; g). The end of the first power output shaft is connected to a fourth shaft seat and having a third driving gear, the third driving gear is a bevel wheel, a third driven gear is a bevel wheel arranged on the upper end of the vertical shaft and be screwed with the third driving gear, a fourth driven gear is a bevel wheel arranged at the bottom of the vertical shaft; a driving mechanism arranged at the front of the outer frame of the bed frame, comprising: a). a first driving rod, an end of the first driving rod set through a fifth shaft seat and having a fourth driven gear, the fourth driven gear is a bevel wheel and screwed with the fourth driving gear, and the other end of the first driving rod set through a sixth shaft seat; b). a second driving rod is arranged on the same axial and drove by the first driving rod, an end of the second driving rod set through a seventh shaft seat and the other end set through an eighth shaft seat; c). a first driving part arranged on the first driving rod includes a first holder body for the first driving rod to set through, and the first driving rod has a fifth driving gear in the first holder body, and the first holder body has a ninth shaft seat being vertical to the first driving rod; d). a second clutch arranged axially among the first driving rod and the second driving rod for controlling the combination status of the first driving rod and the second driving rod, the second clutch includes a third bonding part connected to the end of the first driving rod, a second tube sleeve arranged on the end of the second driving rod, and the second tube sleeve is able to slide on the second driving rod, a fourth bonding part connected to the end of the second tube sleeve and can be axially engaged or disengaged with the third bonding part; a sliding block connected to the second tube sleeve, a guide cable, an end of the guide cable is fixed on the lateral side of the seventh shaft seat and the core of the guide cable is extended out of the seventh shaft seat and connected to the sliding block, a second spring is arranged on the core and has a axial thrust applied to the sliding block and the second tube sleeve, and further controls the combination status of the third bonding part and the fourth bonding part, make them be engaged or disengaged. e). a second driving part arranged on the second driving rod includes a second holder body for the second driving rod to set through, and the second driving rod has a sixth driving gear arranged inside the second holder body, and the second holder body has a ten shaft seat being vertical to the second driving rod; f). The other end of the guide cable is connected to the guiding block, and the core connected to the bottom of the operating lever, the operating lever pulls the core and controls the combination status of the third bonding part and the fourth bonding part, make them be engaged or disengaged; a first elevation rod drove by the first driving rod, the trailing end of the first elevation rod is connected to the first crank of the back moveable frame, inside the front end of the first elevation rod has a screw thread, a part of a first screw rod is screwed with the first elevation rod, the other part is set through the first shaft seat of the first driving part and has the fifth driving gear screwed with a fifth driven gear, and further drives the first screwed rod to rotate, then the first elevation rod has a linear displacement for driving the back moveable frame to be horizontal or leaned. a second elevation rod droved by the second driving rod, the trailing end of the second elevation rod is connected to the second crank of the leg moveable frame, inside the front end of the second elevation rod has a screw thread, a part of a second screwed rod is screwed with the second elevation rod, the other part is set through the second shaft seat of the second driving part and has the sixth driving gear screwed with a sixth driven gear, and further drives the second screwed rod to rotate, then the second elevation rod has a linear displacement for driving the leg moveable frame to be horizontal or lowering; wherein the bed board device comprises: at least a back cushion arranged on the back moveable frame, a mattress arranged on the bed frame, in the center of the mattress where corresponds to human buttock position arranged an opening hole, the opening hole is formed forward with U shape, at the central line of the rear side of the opening hole forms a separating gap, furthermore, a plug corresponding to the shape of the opening hole therein arranged flat therein, and the plug is removeable for excretion, at the middle of the mattress several leg cushion arranged on the leg moveable frame, and can be lowering with the leg moveable frame; wherein, the excretion device is arranged below the opening hole of the mattress for catching excreta, at the both side of the bottom of the opening hole arranged a pair of sliding slots; the excretion device comprising: a basin having protruding structure at the both side corresponding to the sliding slot fixing the basin under the opening hole for catching the excreta; a washing device arranged under the bed frame, including: a sprayer arranged forward at the rear side of the opening hole; a water storage bottle can be hanging on the bed frame separately, a pump arranged on the top of the water storage bottle, at the outlet of the water storage bottle has a connector for connecting a tube, the other end of the tube connected to the sprayer, when pressing the pump, the water inside the bottle will be transmitted to the sprayer; whereby by choosing the manual or auto mode of the first clutch of the control device make the power output rod to dives the first driving rod to rotate, and further drive the first elevation rod to move linearly and drives the back moveable frame to be horizontal or leaned; moreover, the second clutch control the connecting status of the first driving rod and the second driving rod to be engaged or disengaged axially, and controls the leg moveable frame to be flat or lowering, so achieves using a power output rod to drive the back moveable frame and the leg moveable frame simultaneously.

### BRIEF DESCRIPTION OF THE DRAWINGS

FIG. 1A is a perspective views of a nursing bed of the prior art.

FIG. 1B is a side views of a nursing bed of the prior art.

FIG. 2A is a perspective views of the present invention according to the applicable embodiment, viewing from front left to back.

FIG. 2B is a perspective views of the bottom of FIG. 2A.

FIG. 2C is a perspective views of the present invention according to the applicable embodiment, showing the status while back moveable frame rising up and leg moveable frame lowering.

FIG. 2D is a perspective views of the bottom of FIG. 2C.

FIG. 2E is a perspective views of the present invention according to another applicable embodiment, viewing from bottom.

FIG. 2F is an exploded perspective views of the excretion device.

FIG. 2G is a schematic diagram illustrating the operating of the excretion device.

FIG. 3A is a perspective views of the transmission device, viewing from front left to back.

FIG. 3B is a perspective views of the transmission device, viewing from front right to back.

FIG. 3C is a perspective views of the transmission device, viewing from bottom.

FIG. 4 is a perspective views of the transmission device, showing the status while back moveable frame rising up and leg moveable frame lowering.

FIG. 5 is a top view of the transmission device.

FIG. 6 is a left side view of the transmission device.

FIG. 7 is a right side view of the transmission device.

FIG. 8A is a perspective views of the transmission device, viewing from front left to back.

FIG. 8B is a zoom in perspective views of the 8B in the FIG. 8A.

FIG. 8C is a zoom in perspective views of the 8C in the FIG. 8A.

FIG. 8D is a zoom in perspective views of the 8D in the FIG. 8A.

FIG. 8E is a zoom in perspective views of the 8E in the FIG. 8A.

FIG. 9A is a perspective views of the transmission device, viewing from bottom.

FIG. 9B is a zoom in perspective views of the 9B in the FIG. 9A.

FIG. 9C is a zoom in perspective views of the 9C in the FIG. 9A.

FIG. 9D is a zoom in perspective views of the 9D in the FIG. 9A.

FIG. 10A is a top view of the transmission device.

FIG. 10B is a zoom in of the 10B in the FIG. 10A.

FIG. 10C is a schematic diagram illustrating the disengaged status of the clutch showing FIG. 10B.

FIG. 11 is a perspective views of one of the operating status present invention.

FIG. 12 is a schematic diagram illustrating operating status of the present invention while patient is sitting.

FIG. 13 is a schematic diagram illustrating operating status of the present invention while left side is rising up.

FIG. 14 is a schematic diagram illustrating operating status of the present invention while right side is rising up.

### DETAILED DESCRIPTION OF THE PREFERRED EMBODIMENT

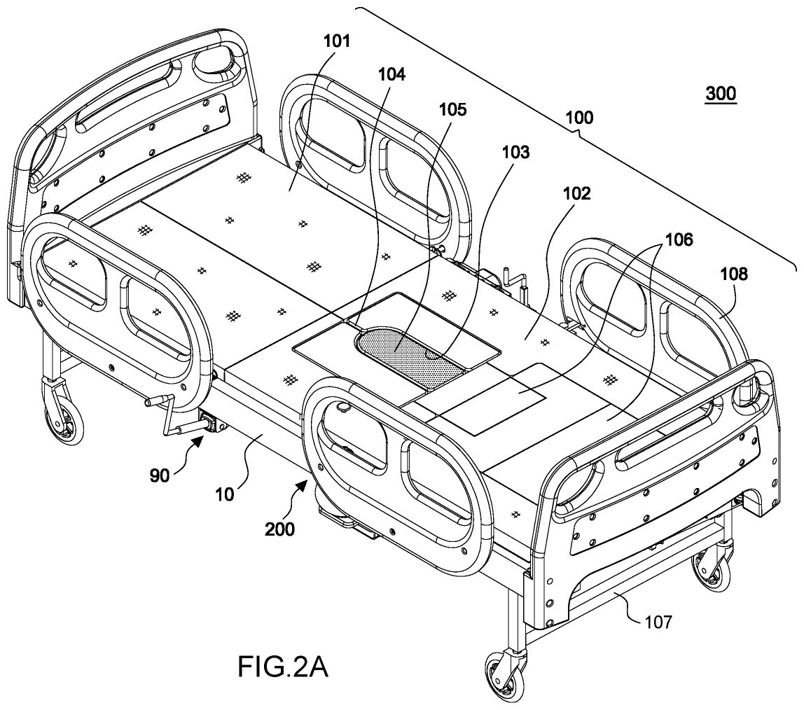

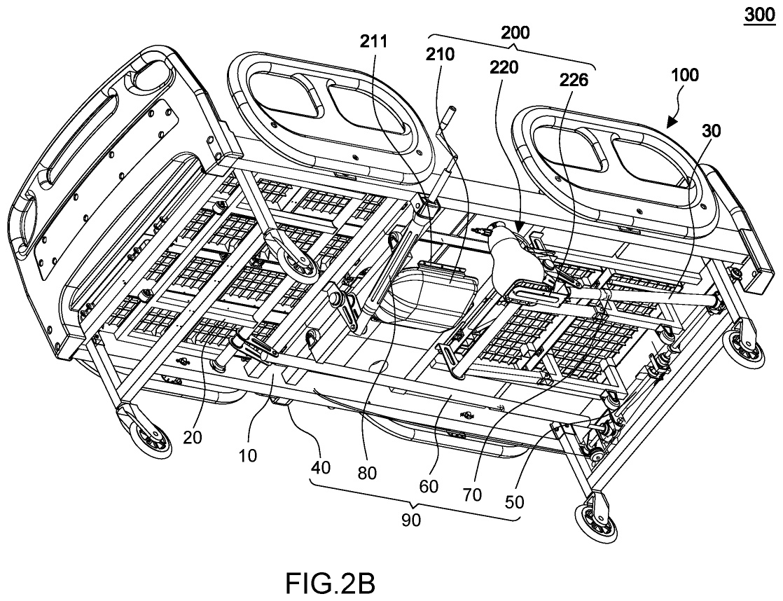

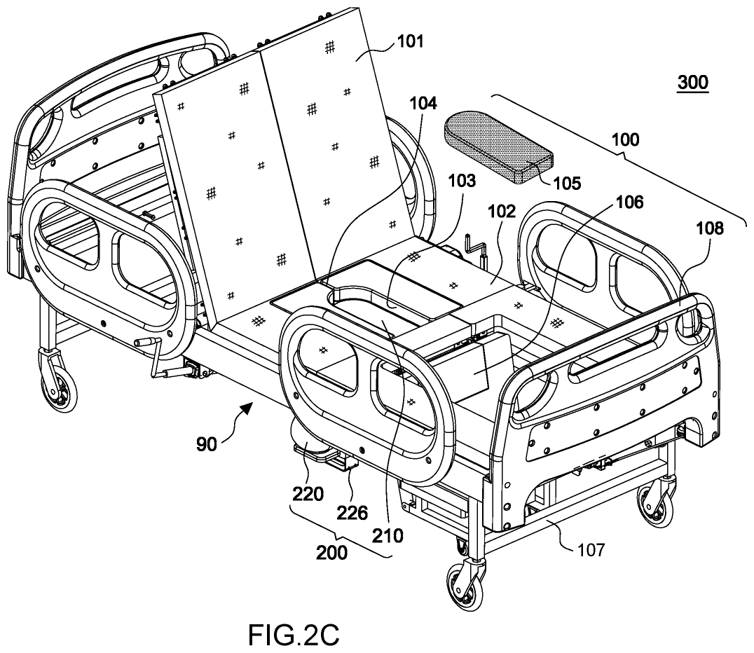

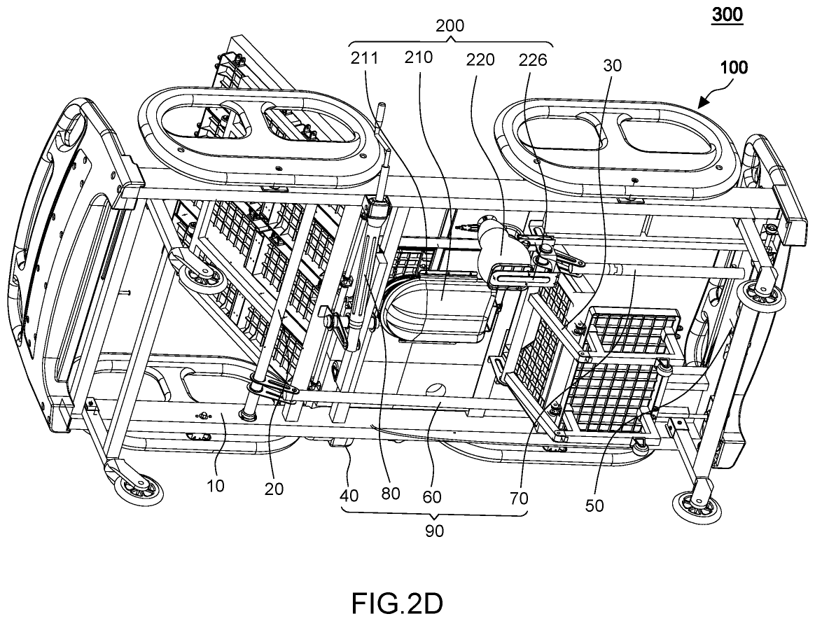

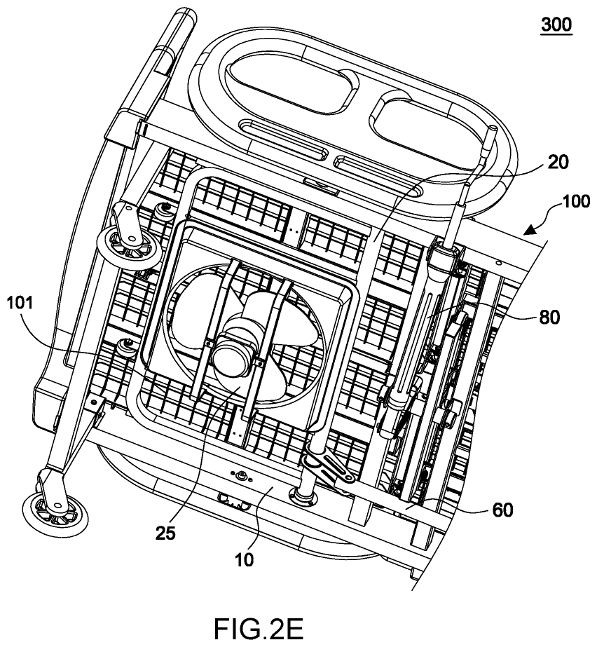

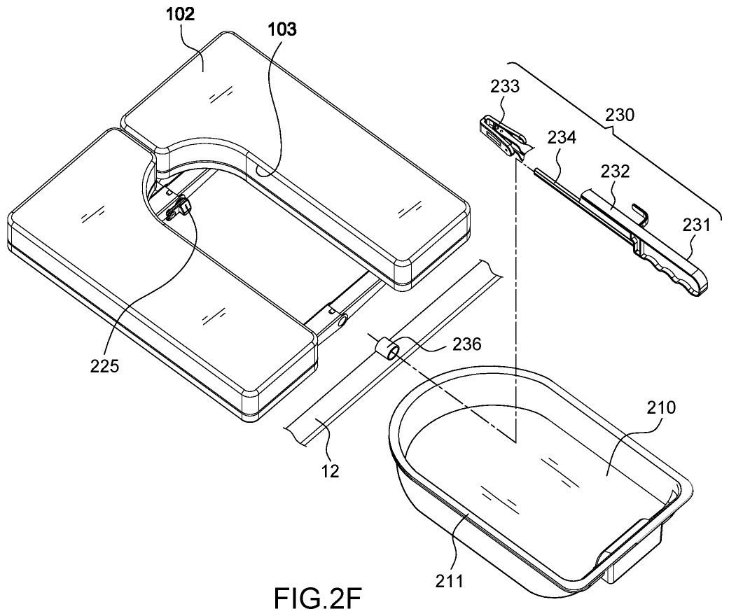

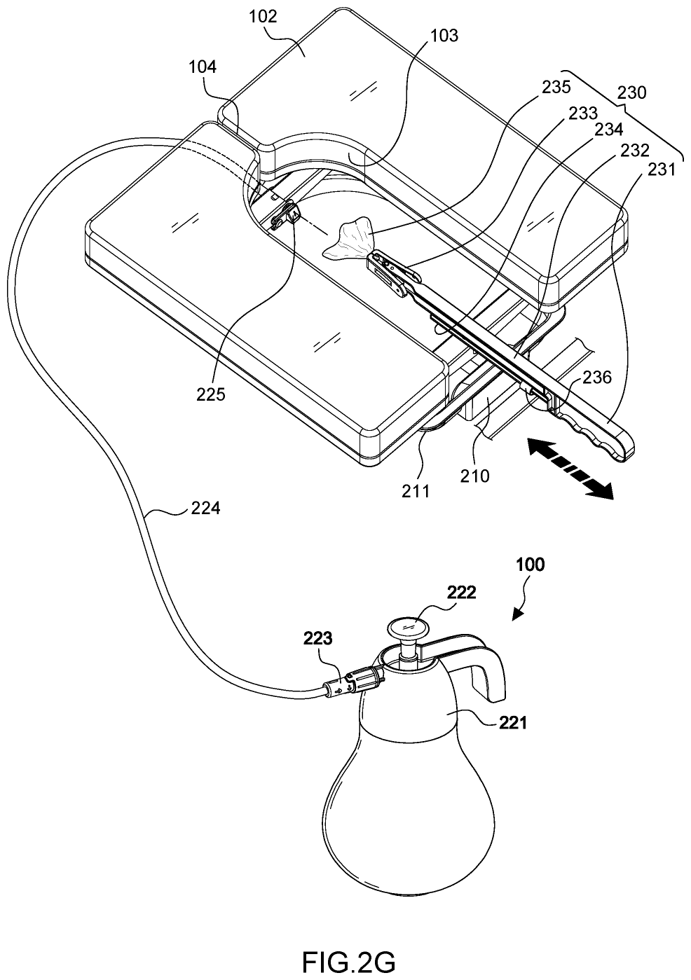

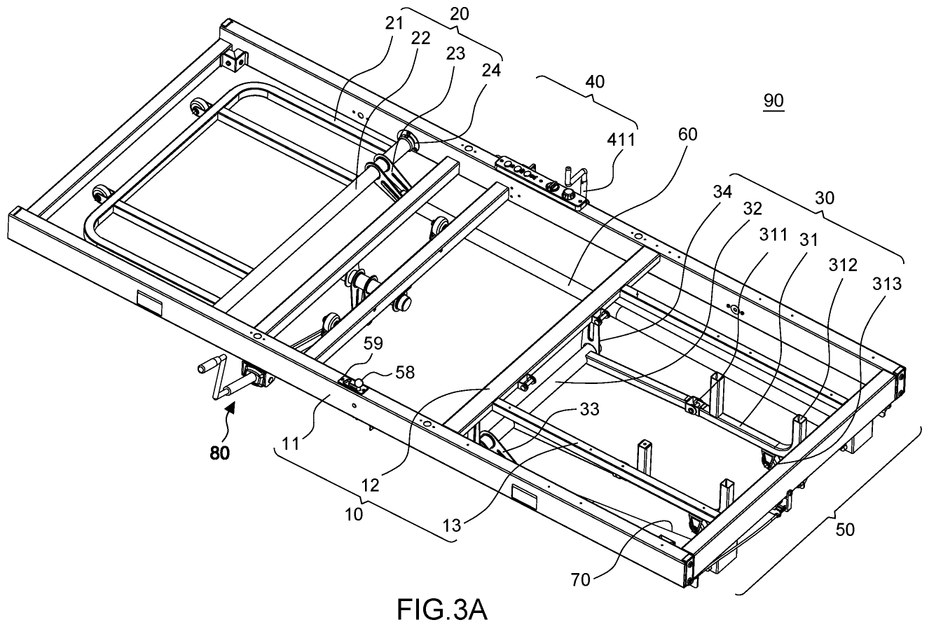

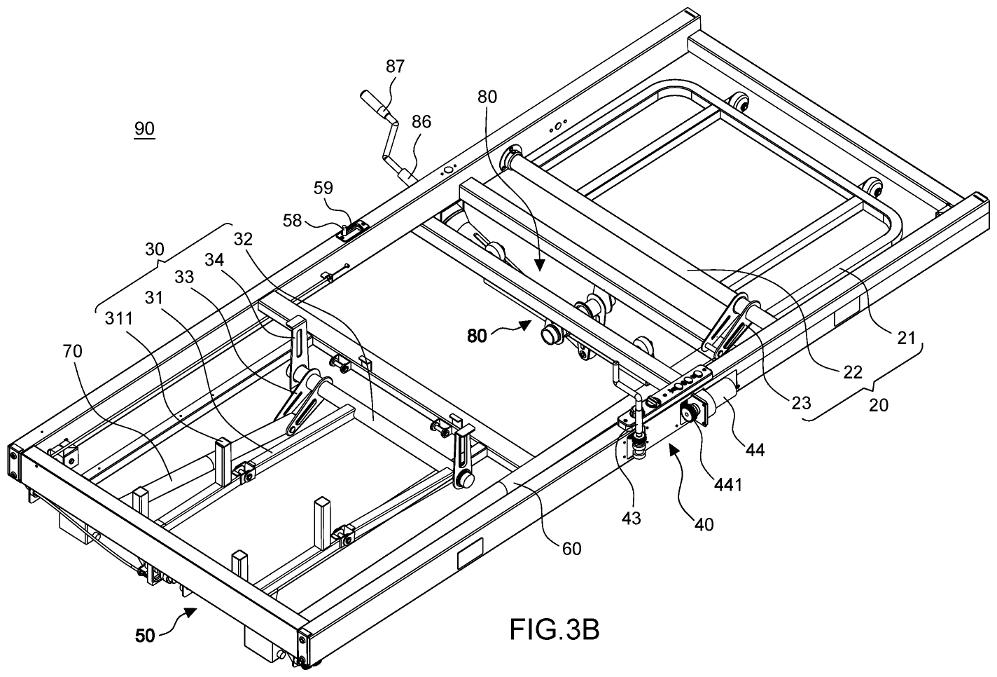

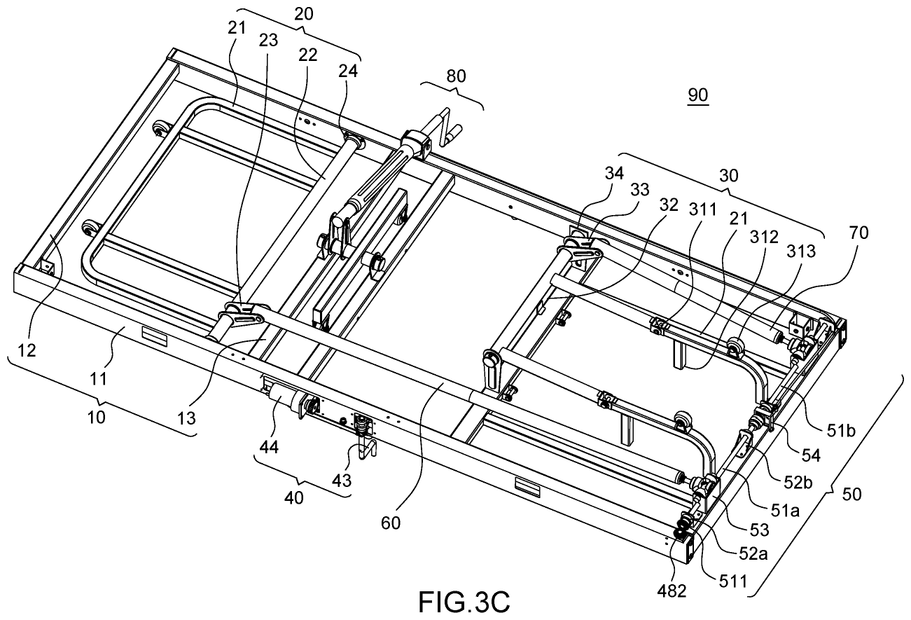

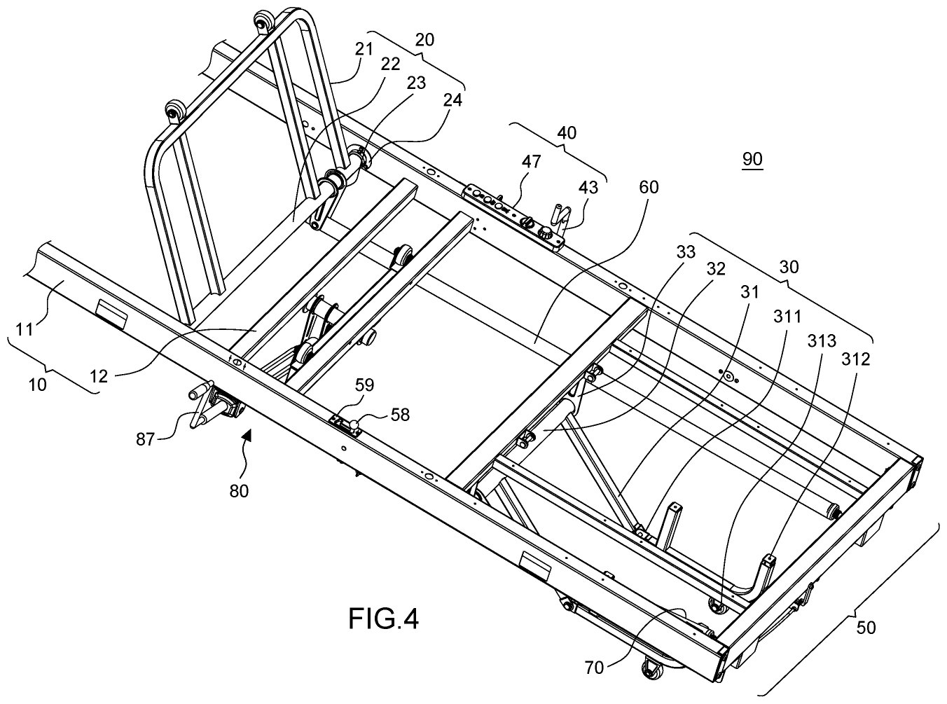

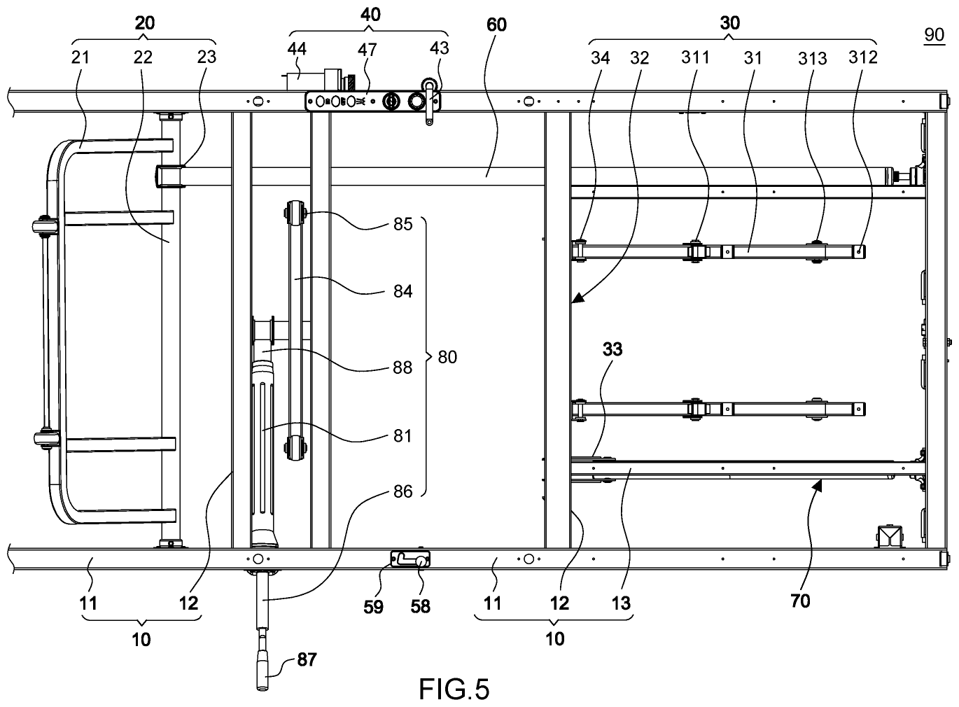

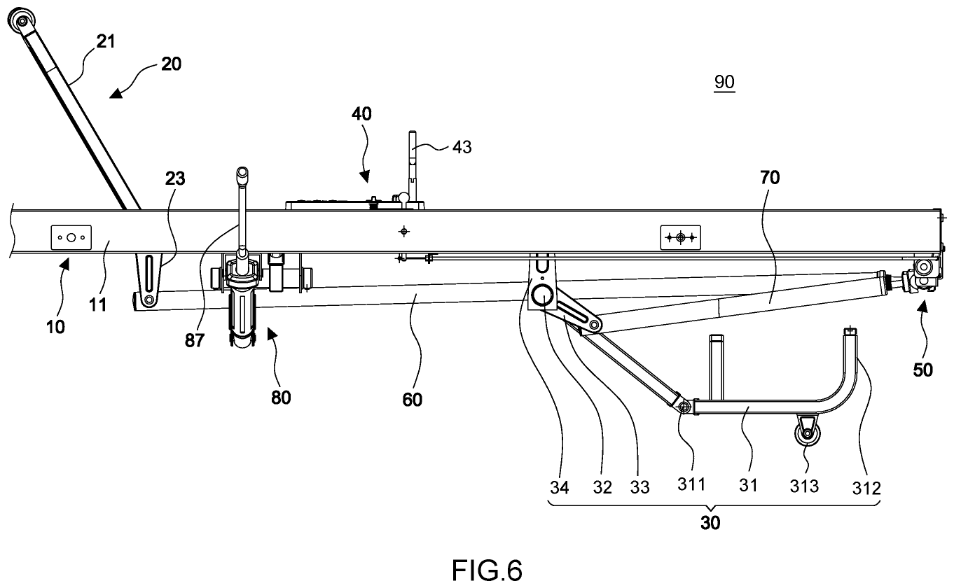

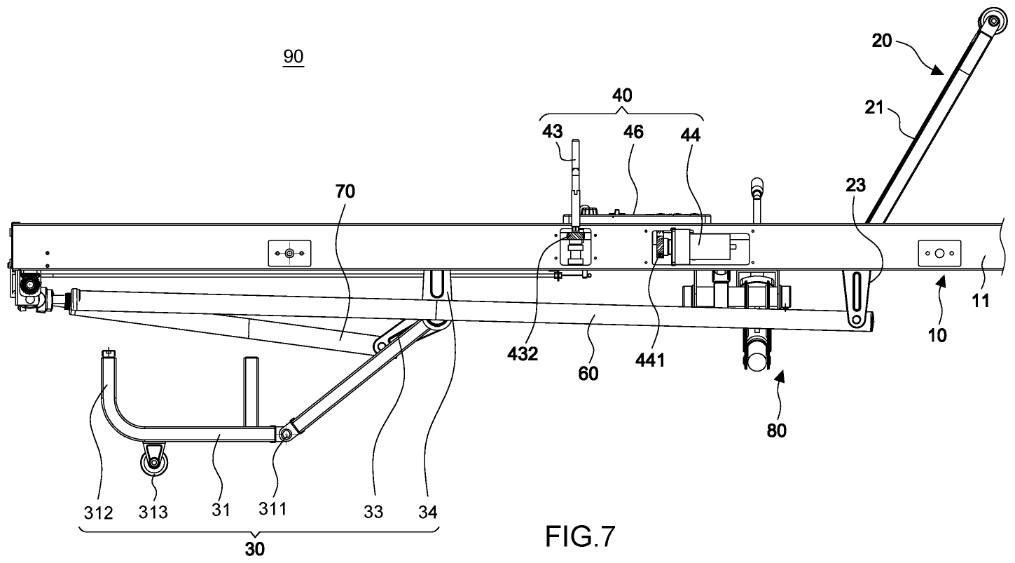

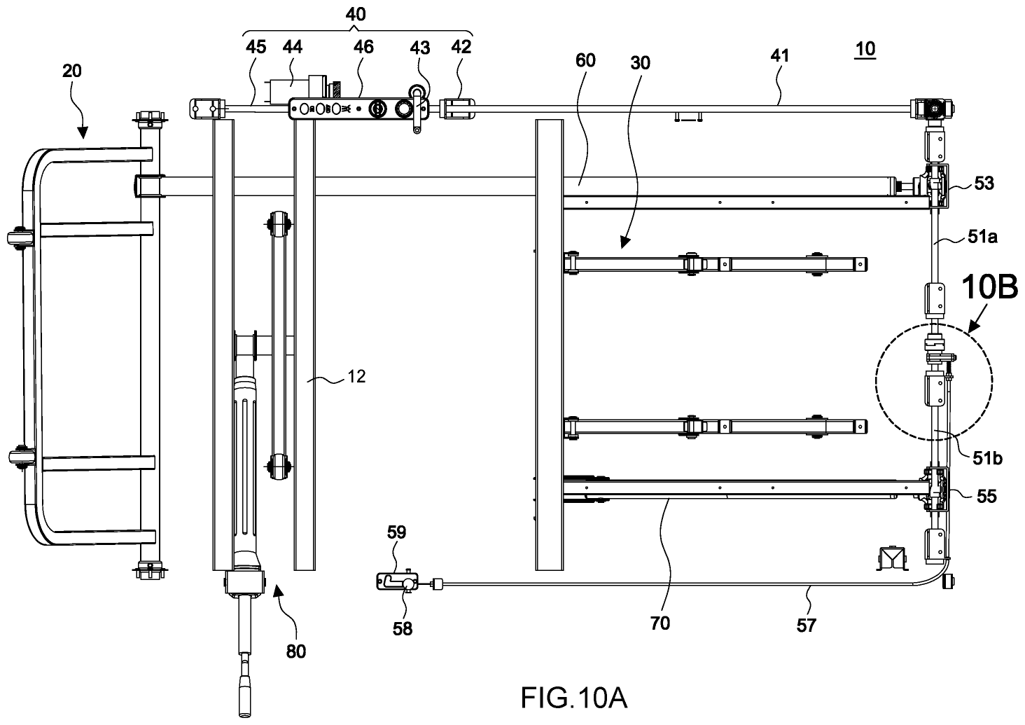

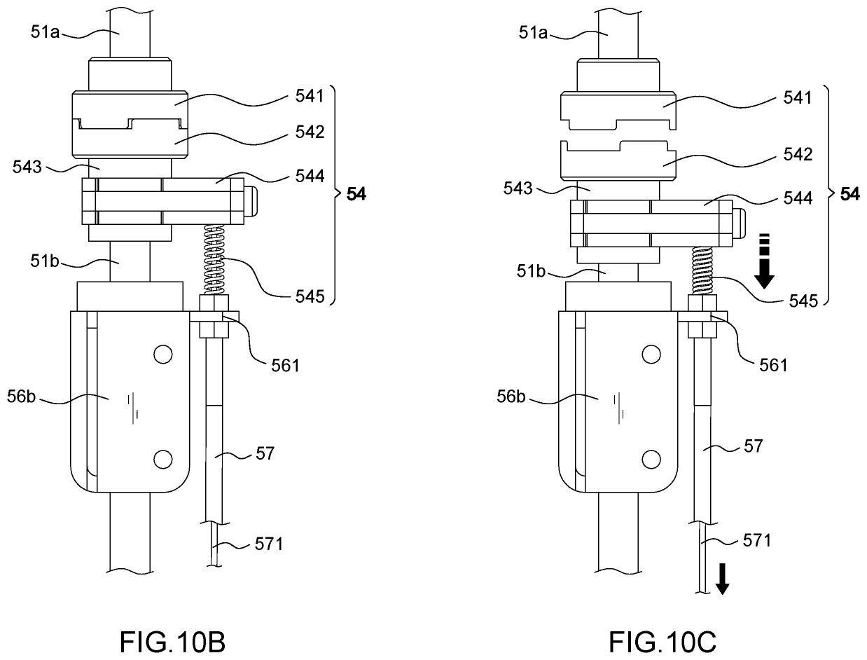

Referring to FIGS. 2A-15, in an applicable embodiment of the nursing bed for sitting excretion 300 of the present invention, comprising: a bed frame 10 formed by an outer frame 11 and multiple frame supports 12 connected to the outer frame 11, and the longer side is defined as horizontal direction, the shorter side is defined as vertical direction; a strength saving transmission device 90 arranged inside the bed frame 10; a bed board device 100 arranged above the strength saving transmission device 90; an excretion device 200 arranged between the bed board device 100 and the strength saving transmission device 90; wherein the strength saving transmission device 90, including: a back moveable frame 20 having a back frame 21, the bottom of the back frame 21 is connected to a first vertical shaft rod 22, the first vertical shaft rod 22 having a first crank 23, a first shaft seat 24 is arranged at the both side of the bed frame 10; a leg moveable frame 30 including two horizontal connecting rods 31 arranged parallelly, the bottom of the horizontal connecting rods 31 are connected to a second vertical shaft rod 32, a second crank 33 arranged on the second vertical shaft rod 33, a second shaft seat 34 arranged on the frame supports 12 on the both side, at the center of the horizontal connecting rods 31 set a hinge 311, and at the outer side of the hinge 311 arranged multiple support bars 312; the hinge 311 is curved while the horizontal connecting rods 31 is lowering as FIG. 4 showing, and on the support bars 312 arranged a leg cushion 106, referring FIG. 2A-2D.

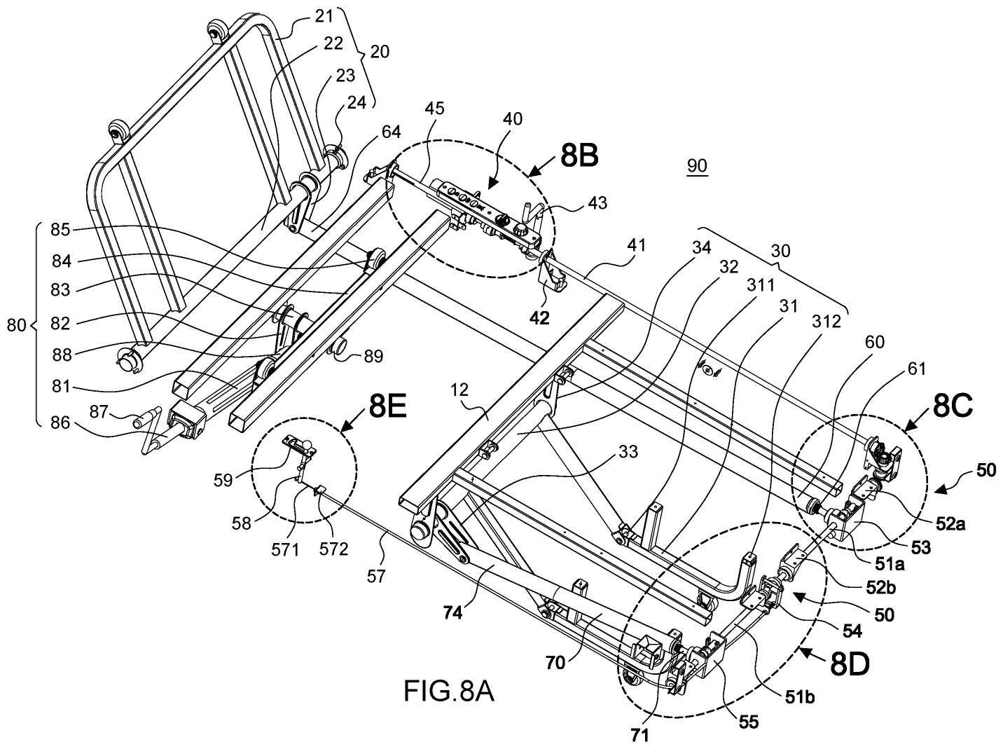

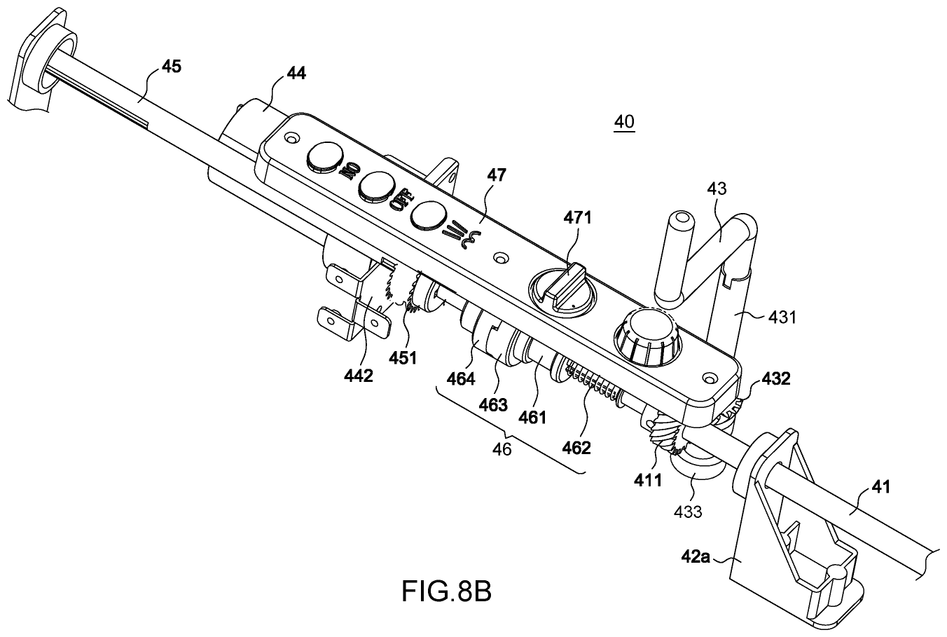

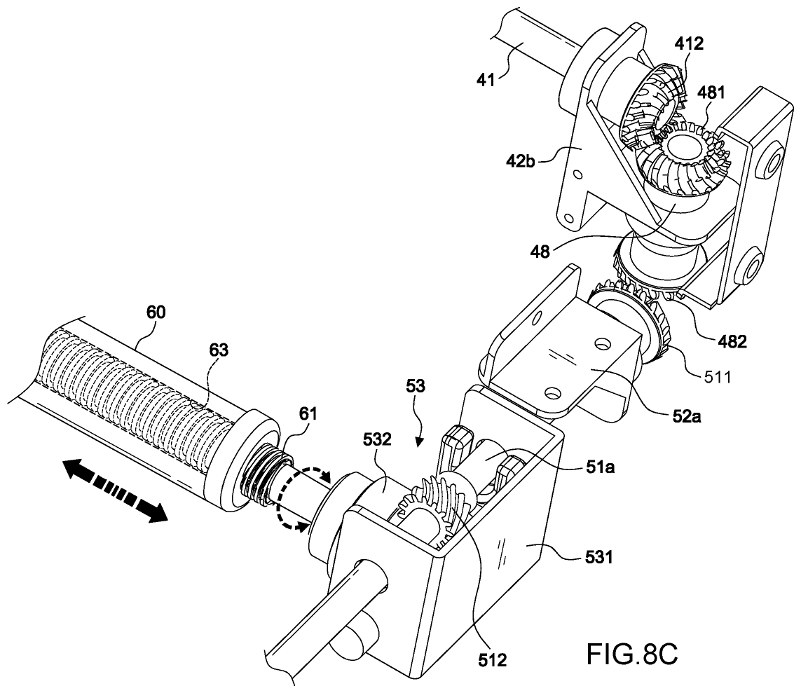

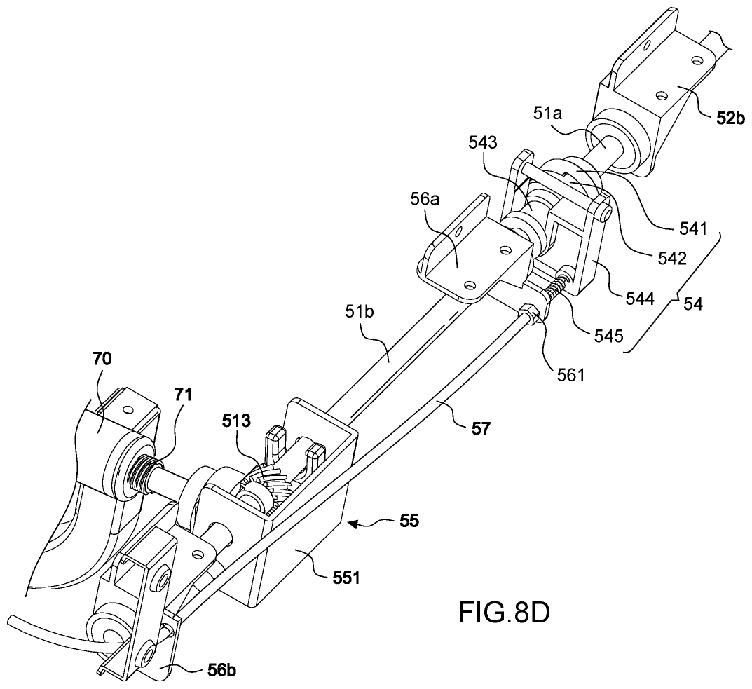

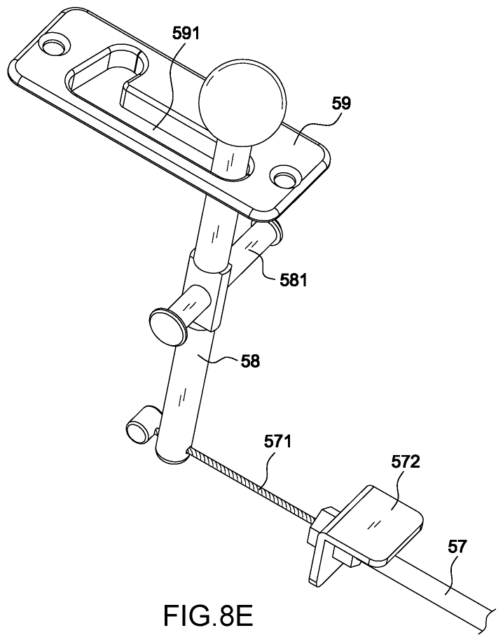

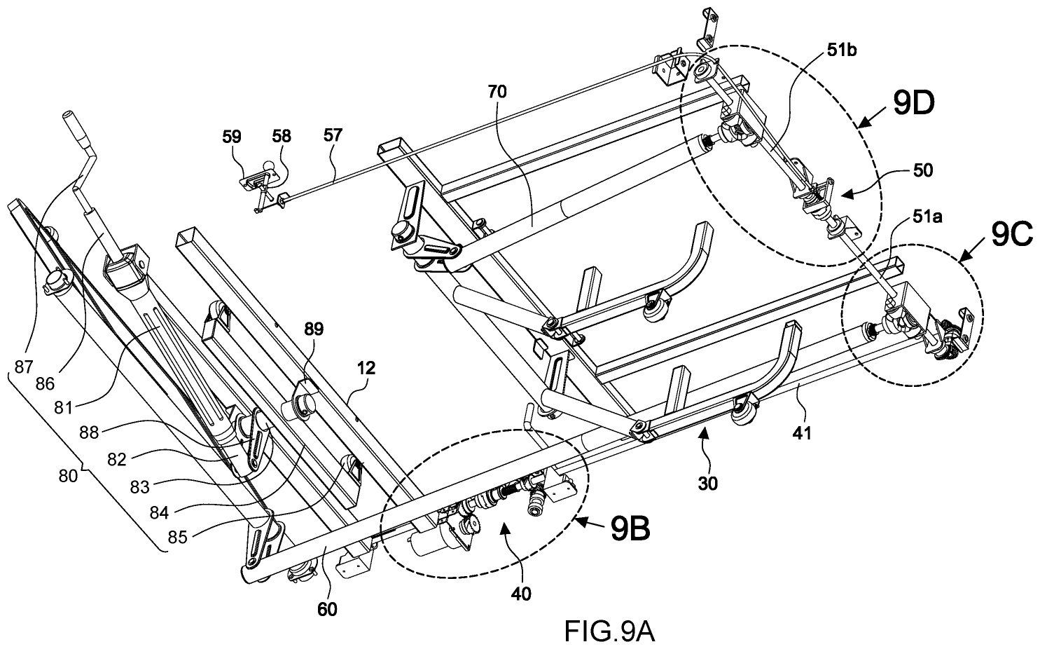

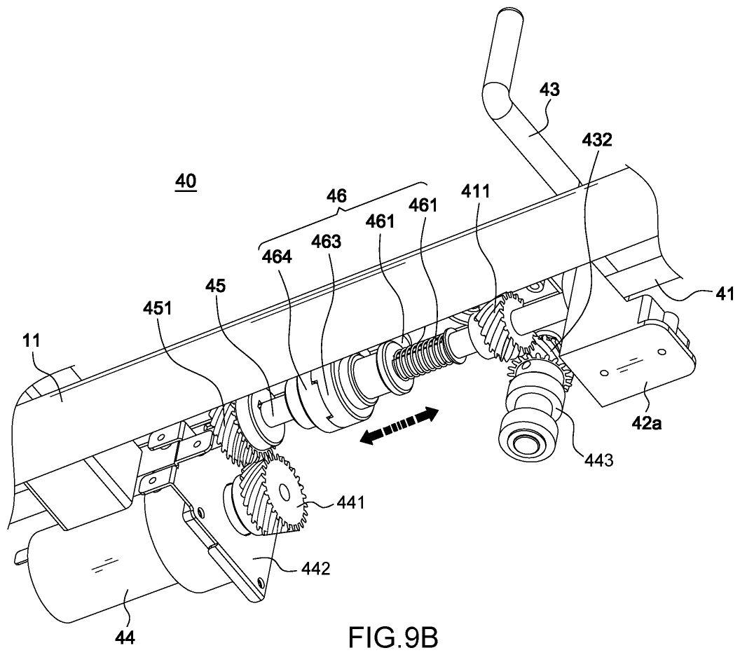

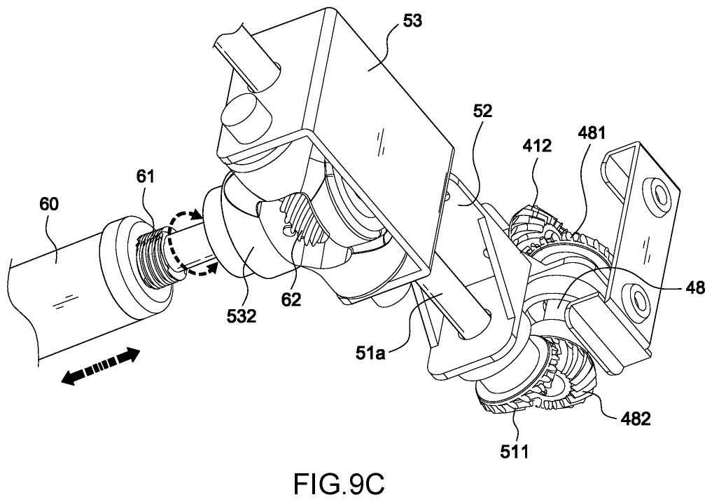

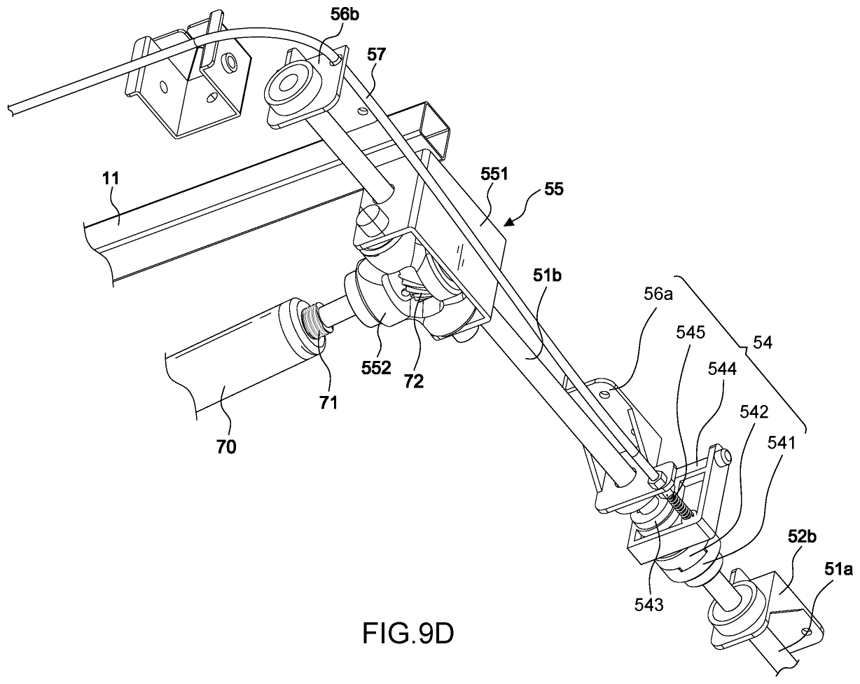

A control device 40 arranged on the outer frame 11 of the bed frame 10, referring FIG. 8B and FIG. 9B, comprising: a first power output shaft 41, at the end of the first power output shaft 41 arranged a third shaft seat 42a, and having a first driven gear 411; a first hand crank 43 capable of turning 360° arranged on the tube body 431, and drives a fourth shaft seat 433 arranged on the first driving gear 432, the first driving gear 432 is screwed with the first driven gear 411, by the rotating of the hand crank 43 drives the power output shaft 41 to rotate; a motor 44 is fixed on the outer frame 11 by a board unit 442, and on spindle of the motor 44 arranged a second driving gear 441. A second power output shaft 45 arranged on the outer frame 11, having a second driven gear 451 screwed with the second driving gear 44, and the second power output shaft 45 is at the same axle corresponding to the first power output shaft 41. A first clutch 46 is arranged axially among the first power output shaft 41 and the second power output shaft 45, the first clutch 46 includes a first tube sleeve 461 and a first spring 462 arranged on the end of the first power output shaft 41, and the first tube sleeve 461 is able to slide on the first power output shaft 41, and at the end of the first tube sleeve 461 which far form the first spring 462 arranged a first bonding part 463 with concave-convex surface, a second bonding part 464 is connected to the second power output shaft 45 and it can be engaged to the first bonding part 463 or disengaged from the first bonding part 463. A panel 47 having a turn knob 471 arranged above the first clutch 46, by turning the turn knob 471 drive the first tube sleeve 461 to move linearly, and further control the combination status of the first bonding part 463 and the second bonding part 464. Referring FIG. 8C and FIG. 9C, the end of the first power output shaft 41 is connected to a fourth shaft seat 42b and having a third driving gear 412, the third driving gear 412 is a bevel wheel, a third driven gear 481 is a bevel wheel arranged on the upper end of the vertical shaft 48 and be screwed with the third driving gear 412, a fourth driven gear 482 is a bevel wheel arranged at the bottom of the vertical shaft 48.

A driving mechanism 50 arranged at the front of the outer frame 11 of the bed frame 10, comprising: A first driving rod 51a, an end of the first driving rod 51a set through a fifth shaft seat 52a and having a fourth driven gear 511, the fourth driven gear 511 is a bevel wheel and screwed with the fourth driving gear 482, and the other end of the first driving rod 51a set through a sixth shaft seat 52b. Referring FIG. 8D and FIG. 9D, a second driving rod 51b is arranged on the same axial and drove by the first driving rod 51a, an end of the second driving rod 51b set through a seventh shaft seat 56a and the other end set through an eighth shaft seat 56b; Referring to FIG. 8C and FIG. 9C, a first driving part 53 arranged on the first driving rod 51a includes a first holder body 531 for the first driving rod 51a to set through, and the first driving rod 51a has a fifth driving gear 512 in the first holder body 531, and the first holder body 531 has a ninth shaft seat 532 being vertical to the first driving rod 51a. A second clutch 54 arranged axially among the first driving rod 51a and the second driving rod 51b for controlling the combination status of the first driving rod 51a and the second driving rod 51b, the second clutch 54 includes a third bonding part 541 connected to the end of the first driving rod 51a, a second tube sleeve 543 arranged on the end of the second driving rod 51b, and the second tube sleeve 543 is able to slide on the second driving rod 51b, a fourth bonding part 542 connected to the end of the second tube sleeve 543 and can be axially engaged or disengaged with the third bonding part 541; a sliding block 544 connected to the second tube sleeve 543, a guide cable 57, an end of the guide cable 57 is fixed on the lateral side 561 of the seventh shaft seat 56a and the core 571 of the guide cable 57 is extended out of the seventh shaft seat 56a and connected to the sliding block 544, a second spring 545 is arranged on the core 571 and has a axial thrust applied to the sliding block 544 and the second tube sleeve 543, and further controls the combination status of the third bonding part 541 and the fourth bonding part 542, make them be engaged or disengaged. Referring to FIG. 8D and FIG. 9D, a second driving part 55 arranged on the second driving rod 51b includes a second holder body 551 for the second driving rod 51b to set through, and the second driving rod 51b has a sixth driving gear 513 arranged inside the second holder body 551, and the second holder body 551 has a ten shaft seat 552 being vertical to the second driving rod 51b; Referring to FIG. 8E, the other end of the guide cable 57 is connected to the guiding block 572, and the core 571 connected to the bottom of the operating lever 58, the operating lever 58 pulls the core 571 and controls the combination status of the third bonding part 541 and the fourth bonding part 542, make them be engaged or disengaged; in this embodiment, a shaft bolt 581 set through the middle of the operating lever 58 axially, making the operating lever 58 be able to move back and forth with the shaft bolt 58 as axis, the movement pulls the core 571, and further controls the connecting status of the second clutch 54 to be engaged or disengaged, and a positioning plate 59 is fixed on the surface of the outer frame 11 of the bed frame 10, on the positioning plate 59 has a L shaped slot 591 for the operating lever 58 to extend through and be able to move or fixed on the L shaped slot.

Referring FIG. 8C and FIG. 9C, a first elevation rod 60 drove by the first driving rod 51a, the trailing end 64 of the first elevation rod 60 is connected to the first crank 23 of the back moveable frame 20, inside the front end of the first elevation rod 60 has a screw thread 63, a part of a first screw rod 61 is screwed with the first elevation rod 60, the other part is set through the first shaft seat 532 of the first driving part 53 and has the fifth driving gear 512 screwed with a fifth driven gear 62, and further drives the first screwed rod 61 to rotate, then the first elevation rod 60 has a linear displacement for driving the back moveable frame 20 to be horizontal as FIG. 2A showing or leaned as FIG. 4 showing.

As FIG. 8D and FIG. 9D, a second elevation rod 70 droved by the second driving rod 51b, the trailing end 74 of the second elevation rod 70 is connected to the second crank 33 of the leg moveable frame 30, inside the front end of the second elevation rod 70 has a screw thread 73, a part of a second screwed rod 71 is screwed with the second elevation rod 70, the other part is set through the second shaft seat 552 of the second driving part 55 and has the sixth driving gear 513 screwed with a sixth driven gear 72, and further drives the second screwed rod 71 to rotate, then the second elevation rod 70 has a linear displacement for driving the leg moveable frame 30 to be horizontal as FIG. 2A showing or lowering as FIG. 4 showing.

Whereby by choosing the manual or auto mode of the first clutch 46 of the control device 40 make the power output rod 41 to dives the first driving rod 51a to rotate, and further drive the first elevation rod 60 to move linearly and drives the back moveable frame 20 to be horizontal or leaned; moreover, the second clutch 54 control the connecting status of the first driving rod 51a and the second driving rod 51b to be engaged or disengaged axially, and controls the leg moveable frame 30 to be flat or lowering, so achieves using a power output rod 41 to drive the back moveable frame 20 and the leg moveable frame 30 simultaneously.

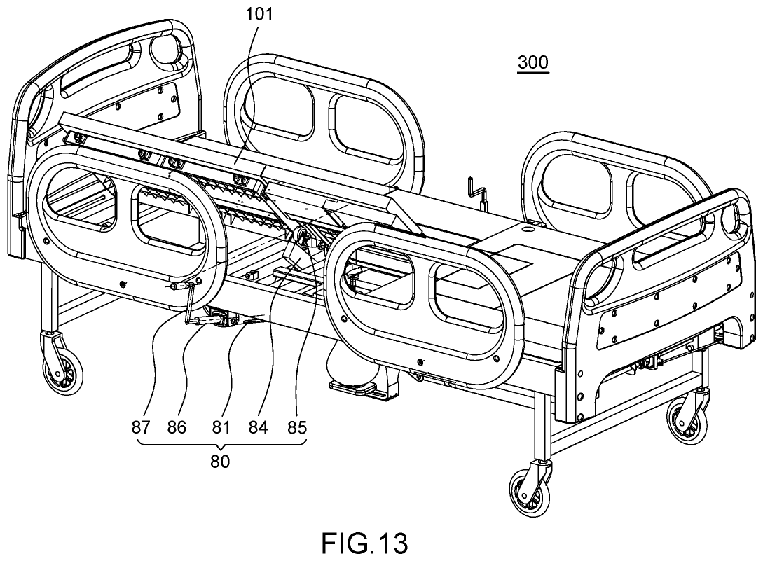

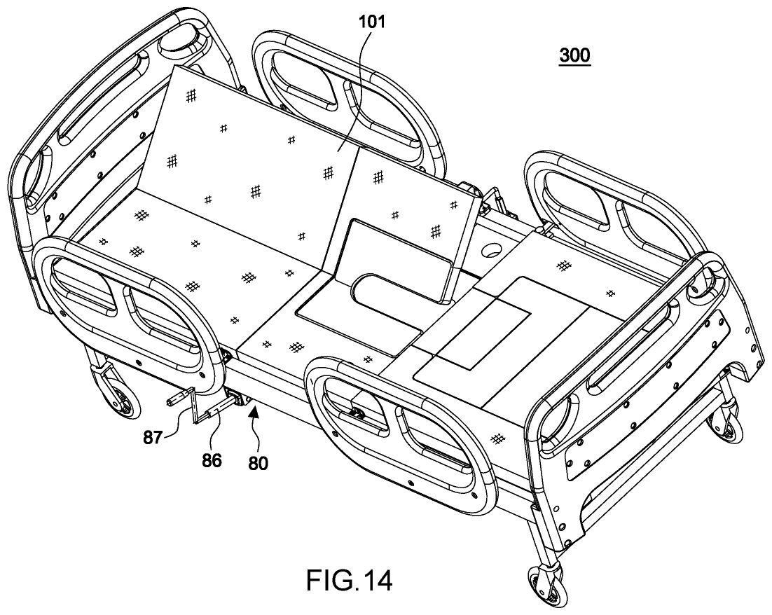

Referring to FIG. 8A and FIG. 9A, the present invention comprises a body turning elevation mechanism 80 arranged axially on the bed frame 10, and at the part which is closed to the back moveable frame 20 of the body turning elevation mechanism 80 comprising: a third elevation rod 81 with screw thread inside; a third screw rod 82 is screwed with the third elevation rod 81 and extend a part out of the third elevation rod 81; a horizontal rod 83 fixed on the frame supports 12 of the bed frame 10 by an eleventh shaft seat 89; a vertical rod 84 arranged vertically on the horizontal rod 83, the horizontal rod 83 can drive vertical rod 84 to move to left side or right side, and on the vertical rod 84 has multiple guide pulley 85; a second hand crank 87 arranged on a tube body 86, the second hand crank 87 can be turned with 360° degree and drives the third screw rod 82 of the third elevation rod 81 to rotate and moves linearly; a third hand crank 88, the top of the third hand crank 88 is fixed on the horizontal rod 83, and the bottom is connected to the third screw rod 82 and controlled by the third screw rod 82 for controlling the rotating of the horizontal rod 83, and further control the movement of the vertical rod 84. The guide pulley 85 pushes of the back cushion 101 rising from the left side as FIG. 13 showing or from the right side as FIG. 14 showing, to help patient turning over and achieve the effect of convenience and strength saving.

Referring FIGS. 2A-2D, the bed board device 100 comprises: at least a back cushion 101 arranged on the back moveable frame 20, a mattress 102 arranged on the bed frame 10, in the center of the mattress 102 where corresponds to human buttock position arranged an opening hole 103, the opening hole 103 is formed forward with U shape, at the central line of the rear side of the opening hole 103 forms a separating gap 104, furthermore, a plug 105 corresponding to the shape of the opening hole 103 therein arranged flat therein, and the plug 105 is removeable for excretion, at the middle of the mattress 102 several leg cushion 106 arranged on the leg moveable frame 30, and can be lowering with the leg moveable frame 30. Moreover, the present invention comprises essential device that general nursing bed having such ad the bed legs 107, the guardrail 108, etc. And behind the back moveable frame 20 can install a fan 25 for cooling the back cushion 101, and the back cushion 101 is air permeable.

Referring FIGS. 2F-2G, the excretion device 200 is arranged below the opening hole 103 of the mattress 102 for catching excreta, at the both side of the bottom of the opening hole 103 arranged a pair of sliding slots 211 as FIG. 2D showing; the excretion device 200 comprising: a basin 210 having protruding structure 212 at the both side corresponding to the sliding slot 211 fixing the basin 210 under the opening hole 103 for catching the excreta.

Referring to FIG. 2G, a washing device 220 arranged under the bed frame 10, including: a sprayer 225 arranged forward at the rear side of the opening hole 103; a water storage bottle 221 can be hanging on the bed frame 10 separately, a pump 222 arranged on the top of the water storage bottle 221, at the outlet of the water storage bottle 221 has a connector 223 for connecting a tube 224, the other end of the tube 224 connected to the sprayer 225, when pressing the pump 222, the water inside the bottle 221 will be transmitted to the sprayer 225; as FIG. 2D showing, in this embodiment, the water storage bottle 221 is arranged on the board unit 226 of the lateral side of the bottom of the bed frame 10, the tube 224 passes from the lateral side of the opening hole 103, then connects to the sprayer 225 from the rear side.

Also, the present invention further comprises a wiping device 230, comprising: a grip 231, an upper bar 232 is extended by the grip 231, a clip 233 arranged at the front end of the upper bar 232, a lower bar 234 extended by the grip 231 arranged parallelly to the upper bar 232, a guide sleeve 236 set through the free end of the lower bar 234, and further make the upper bar 232 and the clip 233 able to move linearly in the opening hole 103, and clamps a tissue paper by the clip 233 of the wiping device 230, then cleans the user's buttock by moving back and forth.

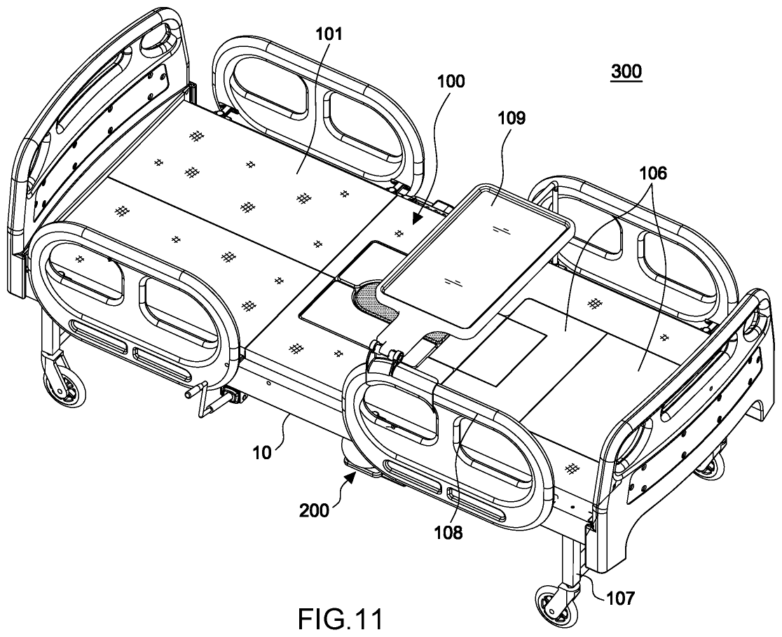

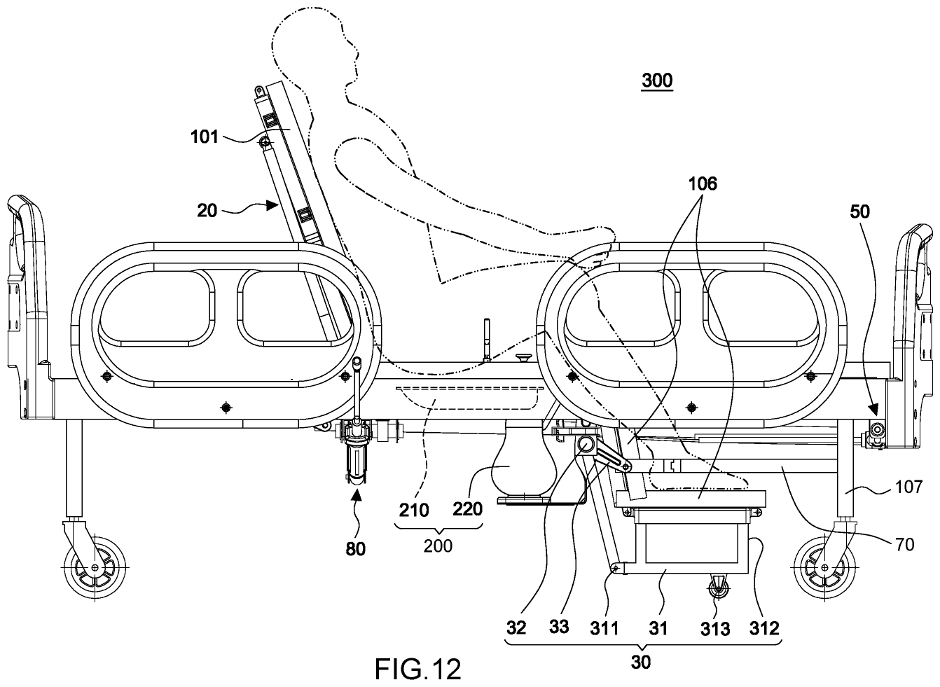

FIG. 11 is a perspective views of one of the operating status present invention, a dining plate 109 can be set on the guardrail 108. As FIG. 12 showing, the operating status of the present invention while patient is sitting, with the feature disclosed above, the present invention allows the patient to sit on the bed and excrete with sitting posture.

The present invention has below benefits:

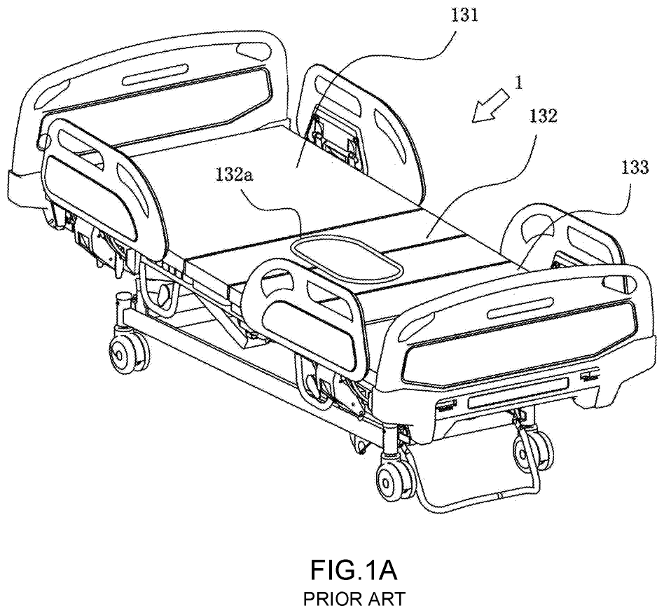

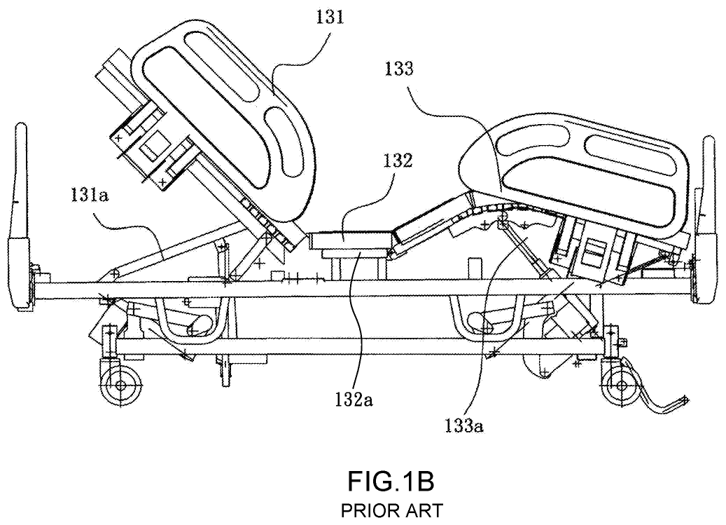

First, the present invention withdraw the method of driving directly by a pneumatic cylinder, because driving directly to move the moveable bed plate 131 and the leg moveable bed plate 133 waste a lot of power, what's more, the driving unit 133a is arranged at the bottom of the leg moveable bed plate 133, so the leg moveable bed plate 133 can only rise up but not fall down, thus, as FIG. 1B showing, when the patient excretes by the care hole 132a, their leg must lift up, it is not a comfortable posture and needed to be improved. In contrast, the present invention uses the law of the lever to amplify the power, therefore, the present invention only needs to rotate the first hand crank 43 by hand to drive the power output rod 41 to drive the driving mechanism 50, and the driving mechanism 50 further drives the first elevation rod 60 and the second elevation rod 70, the first elevation rod 60 can drive the back moveable frame 20 to be horizontal or leaned; the second elevation rod 70 can drives the leg moveable frame 30 to be horizontal a or lowering. The driving method which using the law of the lever achieves the effects of strength saving, power saving, and convenience.

Second, with the clutch 46 of the control device 40, the user can o rotate the first hand crank 43 by hand to drive the power output rod 41 to drive the driving mechanism 50 or use the motor 44 to drive the driving mechanism 50. Thus, the present invention has the benefit with the diversity of operating.

Finally, the second clutch 54 is linked to the driving mechanism 50 and arranged axially among the first driving rod 51a and the second driving rod 51b for controlling the combination status of the first driving rod 51a and the second driving rod 51b, make them to be engaged or disengaged, which means the present invention can choose whether the first driving rod 51a and the second driving rod 51b to be drove simultaneously or not, and whether drive the back moveable frame 20 and the leg moveable frame 30 simultaneously or not. Therefore, the present invention can control how the driving mechanism 50 is worked by patient's requirement.

The present invention discloses a strength saving transmission device, and the present invention provides features of convenience, comfort, and power saving when applying to the nursing bed, and further achieve the effects of allowing the patient excreting with sitting posture to reduce the discomfort and increase the convenience, and achieve self-caring.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A nursing bed for sitting excretion, comprising:
a bed frame formed by an outer frame and multiple frame supports connected to the outer frame, and the longer side is defined as horizontal direction, the shorter side is defined as vertical direction;
a strength saving transmission device arranged inside the bed frame;
a bed board device arranged above the strength saving transmission device;
an excretion device arranged between the bed board device and the strength saving transmission device;
wherein the strength saving transmission device, including:
a back moveable frame having a back frame, the bottom of the back frame is connected to a first vertical shaft rod, the first vertical shaft rod having a first crank, a first shaft seat is arranged at the both side of the bed frame;
a leg moveable frame including two horizontal connecting rods arranged parallelly, the bottom of the horizontal connecting rods are connected to a second vertical shaft rod, a second crank arranged on the second vertical shaft rod, a second shaft seat arranged on the frame supports on the both side, at the center of the horizontal connecting rods set a hinge, and at the outer side of the hinge arranged multiple support bars;
a control device is arranged on the outer frame of the bed frame, comprising:
a). a first power output shaft, at the end of the first power output shaft arranged a third shaft seat, and having a first driven gear;
b). a first hand crank capable of turning 360° arranged on the tube body and drives a fourth shaft seat arranged on the first driving gear, the first driving gear is screwed with the first driven gear, by the rotating of the hand crank drives the power output shaft to rotate;
c). a motor fixed on the outer frame by a board unit, and on spindle of the motor arranged a second driving gear;
d). a second power output shaft arranged on the outer frame, having a second driven gear screwed with the second driving gear, and the second power output shaft is at the same axle corresponding to the first power output shaft;
e). a first clutch arranged axially among the first power output shaft and the second power output shaft, the first clutch includes a first tube sleeve and a first spring arranged on the end of the first power output shaft, and the first tube sleeve is able to slide on the first power output shaft, and at the end of the first tube sleeve which far form the first spring arranged a first bonding part with concave-convex surface, a second bonding part is connected to the second power output shaft and it can be engaged to the first bonding part or disengaged from the first bonding part;
f). a panel having a turn knob arranged above the first clutch, by turning the turn knob drive the first tube sleeve to move linearly, and further control the combination status of the first bonding part and the second bonding part;
g). The end of the first power output shaft connected to a fourth shaft seat and having a third driving gear, the third driving gear is a bevel wheel, a third driven gear is a bevel wheel arranged on the upper end of the vertical shaft and be screwed with the third driving gear, a fourth driven gear is a bevel wheel arranged at the bottom of the vertical shaft;
a driving mechanism is arranged at the front of the outer frame of the bed frame, comprising:
a). a first driving rod, an end of the first driving rod set through a fifth shaft seat and having a fourth driven gear, the fourth driven gear is a bevel wheel and screwed with the fourth driving gear, and the other end of the first driving rod set through a sixth shaft seat;
b). a second driving rod arranged on the same axial and drove by the first driving rod, an end of the second driving rod set through a seventh shaft seat and the other end set through an eighth shaft seat;
c). a first driving part arranged on the first driving rod includes a first holder body for the first driving rod to set through, and the first driving rod has a fifth driving gear in the first holder body, and the first holder body has a ninth shaft seat being vertical to the first driving rod;
d). a second clutch arranged axially among the first driving rod and the second driving rod for controlling the combination status of the first driving rod and the second driving rod, the second clutch includes a third bonding part connected to the end of the first driving rod, a second tube sleeve arranged on the end of the second driving rod, and the second tube sleeve is able to slide on the second driving rod, a fourth bonding part connected to the end of the second tube sleeve and can be axially engaged or disengaged with the third bonding part; a sliding block connected to the second tube sleeve, a guide cable, an end of the guide cable is fixed on the lateral side of the seventh shaft seat and the core of the guide cable is extended out of the seventh shaft seat and connected to the sliding block, a second spring is arranged on the core and has a axial thrust applied to the sliding block and the second tube sleeve, and further controls the combination status of the third bonding part and the fourth bonding part, make them be engaged or disengaged.
e). a second driving part arranged on the second driving rod includes a second holder body for the second driving rod to set through, and the second driving rod has a sixth driving gear arranged inside the second holder body, and the second holder body has a ten shaft seat being vertical to the second driving rod;
f). The other end of the guide cable connected to the guiding block, and the core connected to the bottom of the operating lever, the operating lever pulls the core and controls the combination status of the third bonding part and the fourth bonding part, make them be engaged or disengaged;
a first elevation rod is drove by the first driving rod, the trailing end of the first elevation rod is connected to the first crank of the back moveable frame, inside the front end of the first elevation rod has a screw thread, a part of a first screw rod is screwed with the first elevation rod, the other part is set through the first shaft seat of the first driving part and has the fifth driving gear screwed with a fifth driven gear, and further drives the first screwed rod to rotate, then the first elevation rod has a linear displacement for driving the back moveable frame to be horizontal or leaned.
a second elevation rod droved by the second driving rod, the trailing end of the second elevation rod is connected to the second crank of the leg moveable frame, inside the front end of the second elevation rod has a screw thread, a part of a second screwed rod is screwed with the second elevation rod, the other part is set through the second shaft seat of the second driving part and has the sixth driving gear screwed with a sixth driven gear, and further drives the second screwed rod to rotate, then the second elevation rod has a linear displacement for driving the leg moveable frame to be horizontal or lowering;
wherein the bed board device comprises:
at least a back cushion arranged on the back moveable frame, a mattress arranged on the bed frame, in the center of the mattress where corresponds to human buttock position arranged an opening hole, the opening hole is formed forward with U shape, at the central line of the rear side of the opening hole forms a separating gap, furthermore, a plug corresponding to the shape of the opening hole therein arranged flat therein, and the plug is removeable for excretion, at the middle of the mattress several leg cushion arranged on the leg moveable frame, and can be lowering with the leg moveable frame;
wherein, the excretion device is arranged below the opening hole of the mattress for catching excreta, at the both side of the bottom of the opening hole arranged a pair of sliding slots; the excretion device comprising:
a basin having protruding structure at the both side corresponding to the sliding slot fixing the basin under the opening hole for catching the excreta; a washing device arranged under the bed frame, including: a sprayer arranged forward at the rear side of the opening hole; a water storage bottle can be hanging on the bed frame separately, a pump arranged on the top of the water storage bottle, at the outlet of the water storage bottle has a connector for connecting a tube, the other end of the tube connected to the sprayer, when pressing the pump, the water inside the bottle will be transmitted to the sprayer;
whereby by choosing the manual or auto mode of the first clutch of the control device make the power output rod to dives the first driving rod to rotate, and further drive the first elevation rod to move linearly and drives the back moveable frame to be horizontal or leaned; moreover, the second clutch control the connecting status of the first driving rod and the second driving rod to be engaged or disengaged axially, and controls the leg moveable frame to be flat or lowering, so achieves effect of using a power output rod to drive the back moveable frame and the leg moveable frame simultaneously.

2. The nursing bed for sitting excretion as claimed in claim 1, wherein comprises a body turning elevation mechanism arranged axially on the bed frame, and at the part which is closed to the back moveable frame of the body turning elevation mechanism comprising:
a third elevation rod with screw thread inside;
a third screw rod screwed with the third elevation rod and extends a part out of the third elevation rod;
a horizontal rod fixed on the frame supports of the bed frame by an eleventh shaft seat;
a vertical rod arranged vertically on the horizontal rod, the horizontal rod can drive vertical rod to move to left side or right side, and on the vertical rod has multiple guide pulley;
a second hand crank arranged on a tube body, the second hand crank can be turned with 360° degree and drives the third screw rod of the third elevation rod to rotate and moves linearly;
a third hand crank, the top of the third hand crank is fixed on the horizontal rod, and the bottom is connected to the third screw rod and controlled by the third screw rod for controlling the rotating of the horizontal rod, and further controls the movement of the vertical rod.

3. The nursing bed for sitting excretion as claimed in claim 1, wherein a shaft bolt set through the middle of the operating lever axially, making the operating lever be able to move back and forth with the shaft bolt as axis, the movement pulls the core, and further controls the connecting status of the second clutch to be engaged or disengaged, and a positioning plate is fixed on the surface of the outer frame of the bed frame, on the positioning plate has a L shaped slot for the operating lever to extend through and be able to move or fixed on the L shaped slot.

4. The nursing bed for sitting excretion as claimed in claim 1, wherein the excretion device further comprises a wiping device, comprising: a grip, an upper bar is extended by the grip, a clip arranged at the front end of the upper bar, a lower bar extended by the grip arranged parallelly to the upper bar, a round tube set through the free end of the lower bar, and further make the upper bar and the clip be able to move linearly in the opening hole, and clamping a tissue paper by the clip of the wiping device, then cleans the user's buttock by moving back and forth.
